(19) United States
(12) Patent Application Publication
(10) Pub. No.: US 2020/0034649 A1
(43) Pub. Date: Jan. 30, 2020

(54) OBJECT TRACKING SYSTEM, INTELLIGENT IMAGING DEVICE, OBJECT FEATURE EXTRACTION DEVICE, AND OBJECT FEATURE EXTRACTION METHOD

(71) Applicant: NEC Corporation, Minato-ku, Tokyo (JP)

(72) Inventor: Ryoma OAMI, Tokyo (JP)

(73) Assignee: NEC Corporation, Minato-ku, Tokyo (JP)

(21) Appl. No.: 16/491,643

(22) PCT Filed: Mar. 13, 2018
(86) PCT No.: PCT/JP2018/009657

§ 371 Date: Sep. 6, 2019

(30) Foreign Application Priority Data
Mar. 22, 2017 (JP) 2017-055913

(51) Int. Cl. G06K 9/62; G06K 9/00; G06K 9/32; G06K 9/46

(52) U.S. Cl. CPC G06K 9/6202; G06K 9/00362; G06K 9/6262; G06K 9/4642; G06K 9/6228; G06K 9/3233

(57) ABSTRACT

An object feature extraction device according to an aspect of the present invention includes: at least one memory storing instructions; and at least one processor configured to execute the instructions to: detect an object from an image, and generate area information indicating an area where the object is present, and resolution information pertaining to resolution of the object; and extract, from the image within an area defined by the area information, a feature indicating a feature of the object in consideration of the resolution information.

### TECHNICAL FIELD

The present invention relates to an object tracking system, an intelligent imaging device, an object feature extraction device, an object feature extraction method, and a storage medium.

### BACKGROUND ART

As object tracking of this type, employing a plurality of cameras, a technique of PTL 1 is known. PTL 1 discloses a method of determining whether persons are identical to one another among cameras on the basis of combinations of a plurality of features each of which represents a face, a hairstyle, an arm or a hand, a leg portion, a garment, personal belongings, a way of walking, voice, and the like. In this case, validity for each of the plurality of features is calculated, a feature is selected on the basis of the validity, and matching between persons is performed by using the selected feature. The validity is calculated by multiplying a ratio of output of the feature to a sum of outputs of all features by a frequency of appearance. For example, when a person is walking and approaching from far, validity of a feature of a face image is lower, since a size of a face is too small, and validity of a texture feature, a color component feature, and the like that are features of a garment is higher.

### CITATION LIST

### Patent Literature

[PTL 1] Japanese Patent No. 5008269

### SUMMARY OF INVENTION

### Technical Problem

However, in the technique described in PTL 1, since selection as to whether a feature is used for matching is made based on determination as to whether validity exceeds a threshold value, it is difficult to perform matching while sequentially changing a degree of considering a feature. For example, when validity of a texture feature falls below a threshold value, acquired texture information is not used for matching at all, even when a type of an original texture is narrowed to some extent on the basis of the acquired texture information, and accuracy is lowered. Meanwhile, when validity of a texture feature quality exceeds the threshold value even by a little, matching is performed by using the feature regardless of an influence by resolution. Therefore, accuracy may also be lowered, when a feature varies by resolution of an image. In this way, it is difficult to suppress tracking miss or search miss due to a matching error.

An object of the present invention is to provide a technique, which solves the above-described problem, of generating an object feature, while suppressing tracking miss or search miss due a matching error, which solves the above-described problem.

### Solution to Problem

In order to achieve the above-described object, an object feature extraction device according to an aspect of the present invention includes: object detection means for detecting an object from an image, and generating area information indicating an area where the object is present, and resolution information pertaining to resolution of the object; and feature extraction means for extracting, from the image within an area defined by the area information, a feature indicating a feature of the object in consideration of the resolution information.

In order to achieve the above-described object, an intelligent imaging device includes: at least an imaging unit; and an object feature extraction unit, wherein the object feature extraction unit includes: object detection means for detecting an object from an image captured by the imaging unit, and generating area information and resolution information, the area information indicating an area where the object is present, the resolution information pertaining to resolution of the object; and feature extraction means for extracting, from the image within an area defined by the area information, a feature indicating a feature of the object in consideration of the resolution information.

In order to achieve the above-described object, an object feature extraction method includes: detecting an object from an image, and generating area information indicating an area where the object is present, and resolution information pertaining to resolution of the object; and extracting, from the image within an area defined by the area information, a feature indicating a feature of the object in consideration of the resolution information.

In order to achieve the above-described object, an intelligent imaging method includes: detecting an object from an image captured by an imaging unit, and generating area information and resolution information, the area information indicating an area where the object is present, the resolution information pertaining to resolution of the object; and extracting, from the image within an area defined by the area information, a feature indicating a feature of the object in consideration of the resolution information.

In order to achieve the above-described object, a storage medium stores an object feature extraction program causing a computer to execute: object detection processing of detecting an object from an image, and generating area information indicating an area where the object is present, and resolution information pertaining to resolution of the object; and feature extraction processing of extracting, from the image within an area defined by the area information, a feature indicating a feature of the object in consideration of the resolution information. An aspect of the present invention can be achieved by the object feature extraction program stored in the storage medium described above.

In order to achieve the above-described object, a storage medium stores an intelligent imaging program causing a computer connected with a imaging unit to execute: object detection processing of detecting an object from an image captured by the imaging unit, and generating area information and resolution information, the area information indicating an area where the object is present, the resolution information pertaining to resolution of the object; and feature extraction processing of extracting, from the image within an area defined by the area information, a feature indicating a feature of the object in consideration of the resolution information. An aspect of the present invention can be achieved by the intelligent imaging program stored in the storage medium described above.

### Advantageous Effects of Invention

The present invention is capable of generating an object feature, while suppressing tracking miss or search miss due to a matching error.

### BRIEF DESCRIPTION OF DRAWINGS

FIG. 1 is a block diagram illustrating a configuration of an object feature extraction device according to a first example embodiment of the present invention.

FIG. 2 is a block diagram illustrating a configuration of an object tracking system including an object feature extraction device according to a second example embodiment of the present invention.

FIG. 3 is a flowchart illustrating an operation procedure of the object tracking system including the object feature extraction device according to the second example embodiment of the present invention.

FIG. 4 is a block diagram illustrating a functional configuration of the object feature extraction device (unit) according to the second example embodiment of the present invention.

FIG. 5 is a block diagram illustrating a functional configuration of an object matching unit according to the second example embodiment of the present invention.

FIG. 6 is a block diagram illustrating a hardware configuration of the object feature extraction device (unit) according to the second example embodiment of the present invention.

FIG. 7 is a diagram illustrating a configuration of a feature extraction table in the object feature extraction device (unit) according to the second example embodiment of the present invention.

FIG. 8 is a flowchart illustrating a processing procedure of the object feature extraction device (unit) according to the second example embodiment of the present invention.

FIG. 9 is a diagram illustrating a configuration of a matching table of the object matching unit according to the second example embodiment of the present invention.

FIG. 10 is a flowchart illustrating a processing procedure of the object matching unit according to the second example embodiment of the present invention.

FIG. 11 is a block diagram illustrating a functional configuration of an object feature extraction device (unit) according to a third example embodiment of the present invention.

FIG. 12 is a block diagram illustrating a functional configuration of an object matching unit according to the third example embodiment of the present invention.

FIG. 13 is a block diagram illustrating a functional configuration of an object matching unit according to a fourth example embodiment of the present invention.

FIG. 14 is a block diagram illustrating a functional configuration of an object feature extraction device (unit) according to a fifth example embodiment of the present invention.

FIG. 15 is a diagram illustrating a configuration of an object feature extraction table in the object feature extraction device (unit) according to the fifth example embodiment of the present invention.

FIG. 16 is a flowchart illustrating a processing procedure of the object feature extraction device (unit) according to the fifth example embodiment of the present invention.

FIG. 17 is a block diagram illustrating a functional configuration of an object feature extraction device (unit) according to a sixth example embodiment of the present invention.

### EXAMPLE EMBODIMENT

In the following, example embodiments of the present invention are exemplarily described in detail with reference to the drawings. However, constituent elements described in the following example embodiments are merely an example, and a technical scope of the present invention is not limited to these constituent elements.

### First Example Embodiment

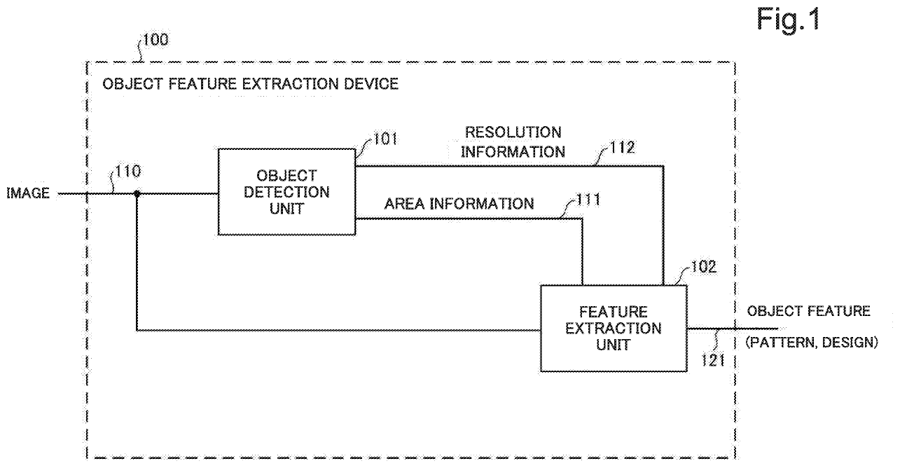

An object feature extraction device as a first example embodiment of the present invention is described by using FIG. 1. An object feature extraction device 100 is a device that extracts an object feature from an image for object tracking.

<<Object Feature Extraction Device>>

As illustrated in FIG. 1, the object feature extraction device 100 includes an object detection unit 101 and a feature extraction unit 102. The object detection unit 101 detects an object from an image 110, and generates area information 111 indicating an area where the object is present, and resolution information 112 pertaining to resolution of the object. The feature extraction unit 102 extracts, from the image 110 within an area defined by the area information 111, an object feature 121 indicating a feature of the object in consideration of the resolution information 112.

(Configuration and Operation of Object Detection Unit)

The object detection unit 101 detects an object from the image 110 which is input, and outputs the result as an object detection result. When the object is a person, a person area is detected by using a detector which has learned an image feature of a person. For example, a detector for detecting based on histograms of oriented gradients (HOG) features, or a detector for directly detecting from an image by using a convolutional neural network (CNN) may be employed. Alternatively, a person may be detected without using an entirety of a person but by using a detector which has learned an area of a part of a person (e.g., a head portion or the like). Also, when the object is a car, similarly, it is possible to detect a car by using a detector which has learned an image feature of a vehicle. Also, when the object is a specific physical object other than the above, a detector which has learned an image feature of the specific physical object may be configured and used.

The area information 111 and the resolution information 112 are acquired with respect to individual objects detected as described above.

The area information 111 is information on an area where the object is present within an image. Specifically, the area information 111 may be information on a circumscribed rectangle of an object area on an image, or silhouette information indicating a shape of an object. The silhouette information is information for distinguishing between a pixel inside an object area, and a pixel outside the object area, and is, for example, image information in which a pixel value of a pixel inside an object area is set to “255”, and a pixel value of a pixel outside the object area is set to “0”. It is possible to acquire the silhouette information by an existing method such as a background subtraction method.

Meanwhile, the resolution information 112 is information indicating a size of an object on an image, and a distance from a camera serving as an imaging unit to an object. For example, the resolution information 112 may be the numbers of pixels regarding a horizontal direction and a vertical direction of an object area on an image, and may be a distance from a camera to an object. A distance from a camera to an object can be acquired by converting two-dimensional coordinates of the camera into coordinates on a real space by using information on a position and a direction of the camera. Information on a position and a direction of a camera can be acquired and be calculated by performing calibration processing when the camera is installed. Resolution information may include not only one type of information but also a plurality of types of information. The area information 111 and the resolution information 112 calculated for each detected object are output to the feature extraction unit 102 that extracts a feature such as a pattern and a texture, for example.

(Feature Extraction Unit)

The feature extraction unit 102 extracts, from the image 110 to be input, the object feature 121 representing a pattern, a texture, and the like, based on the area information 111 and the resolution information 112 for each object output from the object detection unit 101. When the object is a person, a feature of a pattern and a texture of a garment of the person is extracted. At this occasion, the object feature 121 into which the resolution information 112 is also incorporated is generated and output, taking into consideration that a feature of a pattern and a texture may vary depending on resolution of an area. When the resolution information 112 is incorporated, information in which the resolution information 112 is appended as it is to a feature of a pattern and a texture may be output as a whole as the object feature 121, and the object feature 121 may be acquired by applying certain conversion to a feature of a pattern and a texture by using the resolution information 112. In the following description, in the latter case, a feature before applying conversion is referred to as a primary feature.

According to the present example embodiment, a feature is extracted in consideration of a change in feature depending on a resolution, and therefore, the present example embodiment is capable of generating an object feature, while suppressing tracking miss and search miss due to a matching error.

### Second Example Embodiment

Next, an object feature extraction device, and an object tracking system including the object feature extraction device according to a second example embodiment of the present invention are described. The object feature extraction device according to the present example embodiment calculates an object feature with taking a change in feature of a pattern depending on a distance from a camera and resolution into consideration from a time when extracting the feature. Further, the object tracking system including the object feature extraction device according to the present example embodiment is able to suppress tracking miss and search miss by maximally utilizing identification accuracy of a feature, since resolution is reflected on an object feature. For example, when resolution is lowered, a feature of a fine pattern becomes unidentifiable, and it appears as if a pattern is not present. It is possible to suppress tracking miss and search miss even in such a case, since resolution is reflected on a feature in a case where a fine pattern becomes unidentifiable and in a case where a pattern is not originally present.

<<Object Tracking System>>

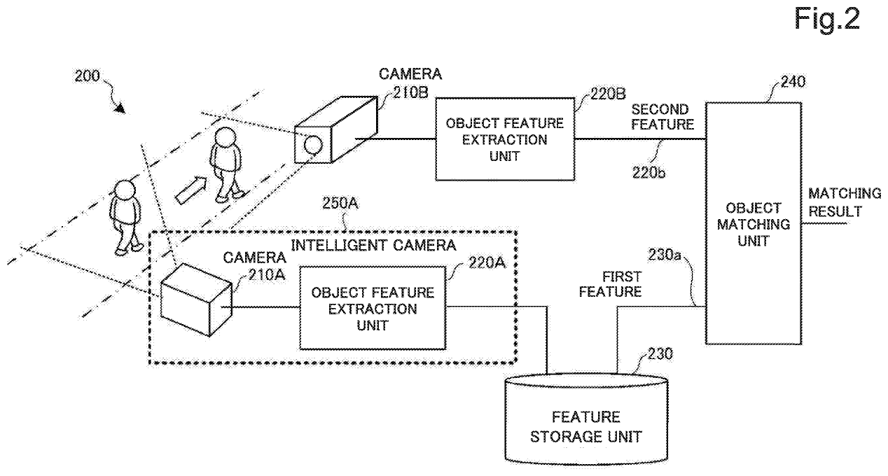

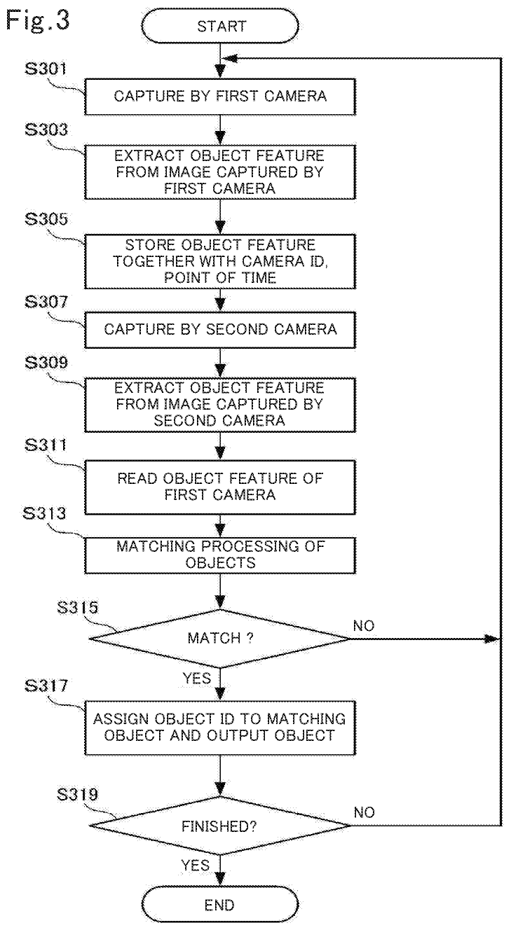

A configuration and an operation of the object tracking system are described with reference to FIGS. 2 and 3.

(System Configuration)

FIG. 2 is a block diagram illustrating a configuration of an object tracking system 200 including an object feature extraction device (unit) 220 according to the present example embodiment.

Referring to FIG. 2, the object tracking system 200 includes an object feature extraction unit 220A, an object feature extraction unit 220B, a feature storage unit 230, and an object matching unit 240.

The object feature extraction unit 220A detects an object from an image captured by a camera 210A, extracts a first feature such as a pattern of the object, and stores the first feature in the feature storage unit 230. The object feature extraction unit 220B detects an object from an image captured by a camera 210B, extracts a second feature 220b such as a pattern of the object, and outputs the second feature 220b to the object matching unit 240. The object matching unit 240 performs matching between the second feature 220b, such as a pattern of an object, output from the object feature extraction unit 220B, and the first feature 230a, such as a pattern of the object, stored in the feature storage unit 230, and outputs the matching result.

Although not illustrated in FIG. 2, when a history regarding objects that are determined to be an identical object in a matching result is accumulated, it is possible to more accurately track an object and to suppress tracking miss and search miss due a matching error. In FIG. 2, a bold broken line surrounding the object feature extraction unit 220A and the camera 210A illustrates that it is possible to implement an intelligent camera 250A integrally including a camera and an object feature extraction unit.

(System Operation)

FIG. 3 is a flowchart illustrating an operation procedure of the object tracking system 200 including the object feature extraction device (unit) 220 according to the present example embodiment.

A video acquired by the camera 210A is input to the object feature extraction unit 220A (S301), an object is detected, and extraction of a feature such as a pattern of the object is performed (S303). This processing is as described above in the first example embodiment. The feature such as a pattern reflecting resolution information is output for the detected object, and is stored in the feature storage unit 230 (S305). The feature storage unit 230 stores the acquired object feature together with information on a camera for which extraction of the object feature is performed, a point of time when the extraction is performed, a position in the camera, and so on. When a certain condition is given from an outside, the feature storage unit 230 outputs an object feature that meets the condition.

Meanwhile, a video acquired by the camera 210B is input to the object feature extraction unit 220B (S307), an object is detected, and extraction of a feature such as a pattern of the object is performed (S309). This processing is also similar to the processing by the object feature extraction unit 220A, and the acquired feature of the object is output to the object matching unit 240.

When the object feature which is extracted by the object feature extraction unit 220B and treated as a query is input, the object matching unit 240 reads, from the feature storage unit 230, the object feature to be used for matching (S311), and performs matching, in which resolution information is reflected, between the object features (S313). Specifically, the object matching unit 240 calculates a degree of similarity between the object features , and determines whether the objects are identical to each other. At this occasion, a point of time when a corresponding object appears on another camera (in this case, the camera 210A) may be predicted, and object features acquired at around the predicted point of time may be read and used for matching. Alternatively, a point of time when a corresponding object appears on another camera (in this case, the camera 210B) may be predicted, and object features acquired at around the predicted point of time may be selected and used for matching. The acquired result is output as an object matching result (S315 to S317).

This procedure is repeated until an instruction to finish from an operator is received (S319).

<<Functional Configuration of Object Feature Extraction Device (Unit)>>

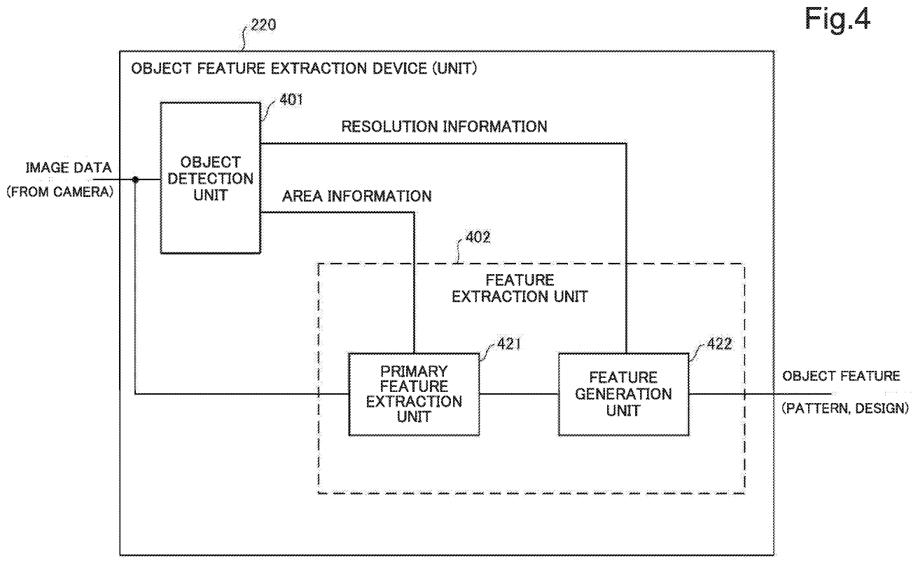

FIG. 4 is a block diagram illustrating a functional configuration of the object feature extraction device (unit) 220 according to the present example embodiment. When the object feature extraction device (unit) 220 is described as an object feature extraction device, the device 220 indicates an independent device; and when the object feature extraction device (unit) 220 is described as an object feature extraction unit, the unit 220 indicates one function combined with another function.

The object feature extraction device (unit) 220 includes an object detection unit 401 and a feature extraction unit 402. The object detection unit 401 is a functional element similar to the object detection unit 101 in FIG. 1, and the feature extraction unit 402 is a functional element similar to the feature extraction unit 102 in FIG. 1.

The feature extraction unit 402 according to the present example embodiment includes a primary feature extraction unit 421 and a feature generation unit 422. The primary feature extraction unit 421 receives image information and area information output from the object detection unit 401 as an input, and outputs a primary feature to the feature generation unit 422. The feature generation unit 422 generates a feature such as a pattern and a texture from the primary feature output from the primary feature extraction unit 421, and resolution information output from the object detection unit 401, and outputs the feature as an object feature.

(Primary Feature Extraction Unit)

The primary feature extraction unit 421 extracts a feature that is a base for a texture and a pattern. For example, the primary feature extraction unit 421 extracts a local feature reflecting a local feature of a pattern. As an extraction method, various methods are employed. First, a point that is a key point is extracted, and a feature in a periphery of the point is extracted. Alternatively, regularly arranged grids are placed on an area, and a feature at a grid point is extracted. At this occasion, an interval between the grids may be normalized according to a size of an object area. As a feature extracted at this occasion, it is possible to employ various features such as scale-invariant feature transform (SIFT), speed-up robust features (SURF), and oriented FAST and rotated BRIEF (ORB). Further, a feature such as a Haar-Like feature, a Gabor wavelet, and histograms of oriented gradients (HOG) may be employed.

Further, an area of an object may be divided into a plurality of subareas, and a feature may be extracted for each of the subareas. When the object is a person, for example, a feature point may be acquired for each of oblong areas acquired by dividing an area of a garment along a horizontal line, and a feature may be extracted. Alternatively, an area may be divided into N divisions in a vertical direction and M divisions in horizontal directions, i.e. divided areas of a certain number, the above-described features may be extracted for the divided areas, respectively, and the features may be joined together into a primary feature. For example, when a feature of one area has L dimensions, and the area is divided into areas of N divisions in a vertical direction and M divisions in a horizontal direction, the features become a vector of (L×M×N) dimensions. A way of division into subareas does not need to be regular. For example, when the object is a person, subareas may be set so as to fit body parts, such as an upper body and a lower body (alternatively, pieces into which each of the upper body and the lower body is further divided).

A primary feature generated as described above is output to the feature generation unit 422.

(Feature Generation Unit)

When the object is, for example, a person, the feature generation unit 422 generates a feature, which is to be used in matching, of a garment or the like on the basis of a feature of a garment output from the primary feature extraction unit 421 and resolution information output from the object detection unit 401; and outputs, as an object feature, the feature.

(First Generation Method)

For example, visual keywords acquired by clustering primary features are generated by learning in advance, and visual keywords to which primary features correspond are determined, and a histogram thereof is generated and set as a feature. At this occasion, the histogram, together with the resolution information which is also appended in a separable form, is set as an object feature. When a primary feature is acquired for each of the subareas, the histogram of visual keywords may be generated for each of the subareas, the subareas may be joined together, and resolution information may be appended to the entirety in a separable form.

(Second Generation Method)

Alternatively, when a histogram of visual keywords is generated, an occurrence probability of each of the visual keywords may be acquired from the acquired primary features by using resolution information, and the histogram may be calculated by performing weighting by a value of the probability. Here, the number of visual keywords is referred to as N, and an individual visual keyword is referred to as xₙ (n=1, . . . , N). Further the number of acquired primary features is referred to as J, and an acquired individual primary feature is referred to as yⱼ (j=1, . . . , J). Further, levels of resolution are classified into K stages by resolution information, and distinguished by a resolution index (k=1, . . . , K). When a resolution index is k, an occurrence probability of the visual keyword xₙ in a case where yⱼ is acquired is described as pₖ(xₙ|yⱼ). When the primary feature yⱼ is acquired, a histogram may be generated by adding a value of the occurrence probability pₖ(xₙ|yⱼ) to a bin associated with the visual keyword xₙ.

Therefore, when a value of a bin of the histogram associated with the visual keyword xₙ is hₙ, hₙ is described as follows.

$$\begin{matrix}[ Math . 1 ] & \\ {h}_{n} = {\sum }_{j = 1}^{j} {P}_{k} ( {x}_{n} \vert {y}_{j} ) & ( 1 )\end{matrix}$$

A value of the occurrence probability pₖ(xₙ|yⱼ) can be written as:

$$\begin{matrix}[ Math . 2 ] & \\ {p}_{k} ( {x}_{n} \vert {y}_{j} ) = \frac{{p}_{k} ( {y}_{j} \vert {x}_{n} ) p ( {x}_{n} )}{{p}_{k} ( {y}_{j} )} = \frac{{p}_{k} ( {y}_{j} \vert {x}_{n} ) p ( {x}_{n} )}{{\sum }_{i = 1}^{I} {p}_{k} ( {y}_{j} \vert {x}_{i} ) p ( {x}_{i} )} & ( 2 )\end{matrix}$$

Here, pₖ(yⱼ|xₙ) is a probability that a feature of a texture pattern of the visual keyword xₙ is yⱼ at a resolution indicated by the resolution index k, and p(xₙ) is a prior probability of the visual keyword xₙ (which represents a frequency of occurrence of the visual keyword xₙ, and does not depend on resolution).

It is possible to acquire in advance pₖ(yⱼ|xₙ) by examining (i.e. learning by using data) how features of the visual keyword xₙ is distributed at a resolution associated with the resolution index k. Also regarding p(xₙ), it is possible to acquire what pattern is frequently used for a garment and to output a distribution by examining in advance texture patterns of various objects (e.g., in a case of a person, texture patterns of garments, patterns generated by layered wearing of garments, and the like). Alternatively, when such prior knowledge is not available, the distribution may be set as a uniform distribution. It is possible to calculate a value of (Math. 2) by using these values.

In this way, pₖ(xₙ|yⱼ) is acquired and stored for each resolution index k, and for each value of the primary feature yⱼ. When the value actually occurs, a feature is calculated according to (Math. 1).

It is possible to calculate an object feature of a pattern and a texture as described above. Also in this case, resolution information may be appended thereto. When primary features are acquired separately for subareas, features may be acquired separately for the subareas, and may be joined into an object feature of a pattern and a texture.

<<Functional Configuration of Object Matching Unit>>

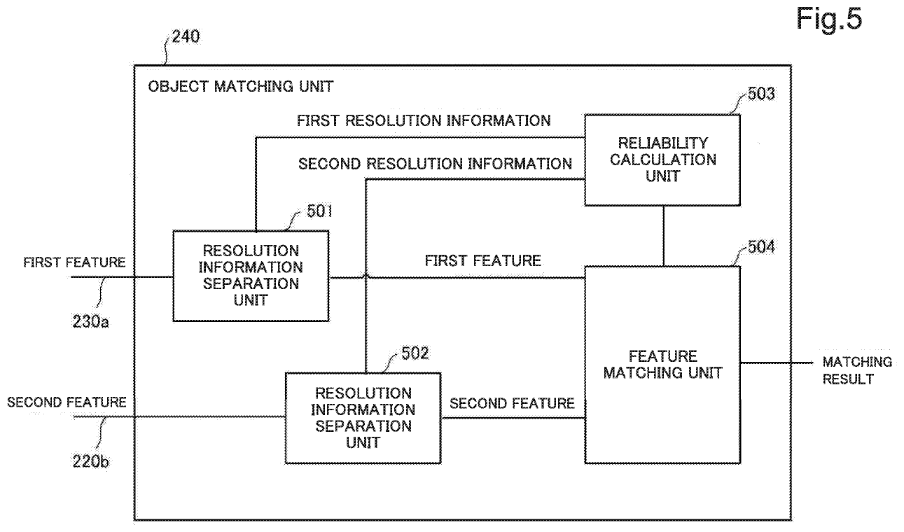

FIG. 5 is a block diagram illustrating a functional configuration of the object matching unit 240 according to the present example embodiment. The object matching unit 240 is a configuration example of an object matching unit in a case where resolution information is integrated with an object feature such as a pattern in a separable state.

(Configuration)

Referring to FIG. 5, the object matching unit 240 includes a resolution information separation unit 501, a resolution information separation unit 502, a reliability calculation unit 503, and a feature matching unit 504. The resolution information separation unit 501 separates first resolution information from the first feature 230a, and outputs the first resolution information and data on the first feature. The resolution information separation unit 502 separates second resolution information from the second feature 220b, and outputs the second resolution information and data on the second feature. The reliability calculation unit 503 calculates a degree of reliability from the first resolution information output from the resolution information separation unit 501, and the second resolution information output from the resolution information separation unit 502; and outputs reliability information that is an index indicating the degree of reliability. The feature matching unit 504 performs matching between the data on the first feature output from the resolution information separation unit 501, and the data on the second feature to be output from the resolution information separation unit 502 on the basis of the degree of reliability calculated by the reliability calculation unit 503, and outputs matching result.

(Operation)

The first feature 230a read from the feature storage unit 230 is input to the resolution information separation unit 501. The resolution information separation unit 501 extracts, from the input first feature 230 a, information corresponding to a resolution, outputs the extracted information as the first resolution information, and outputs, as data on the first feature, data indicating a feature of a pattern other than the resolution. The second feature 220b from the object feature extraction device (unit) 220B is input to the resolution information separation unit 502. Similarly to the resolution information separation unit 501, the resolution information separation unit 502 also separates resolution information, and outputs second resolution information and data on the second feature.

The separated first and second resolution information are input to the reliability calculation unit 503. The reliability calculation unit 503 calculates and outputs, from the resolution information, a degree of reliability indicating a degree at which a matching result between features can be relied.

Meanwhile, the separated data on the first and second features are input to the feature matching unit 504. The feature matching unit 504 performs comparison between object features of patterns and the like. A degree of similarity or a distance between features are simply calculated, and objects are determined to be identical to each other when the objects have a degree of similarity equal to or larger than a predetermined threshold value, i.e. the degree of similarity is high, and then a matching result is output. Alternatively, determination may be made as to whether objects are identical to each other by employing a determiner generated by a neural network or the like, and by inputting data on the first feature and data on the second feature to the determiner. At this occasion, a criterion of matching may be adjusted according to the degree of reliability calculated by the reliability calculation unit 503, and identity determination may be performed. A matching result may not be binary determination as to whether objects are simply identical to each other, but a numerical value indicating a degree of identity may be output as a matching result. Further, a degree of reliability output from the reliability calculation unit 503 may be appended to a matching result.

<<Hardware Configuration of Object Feature Extraction Device (Unit)>>

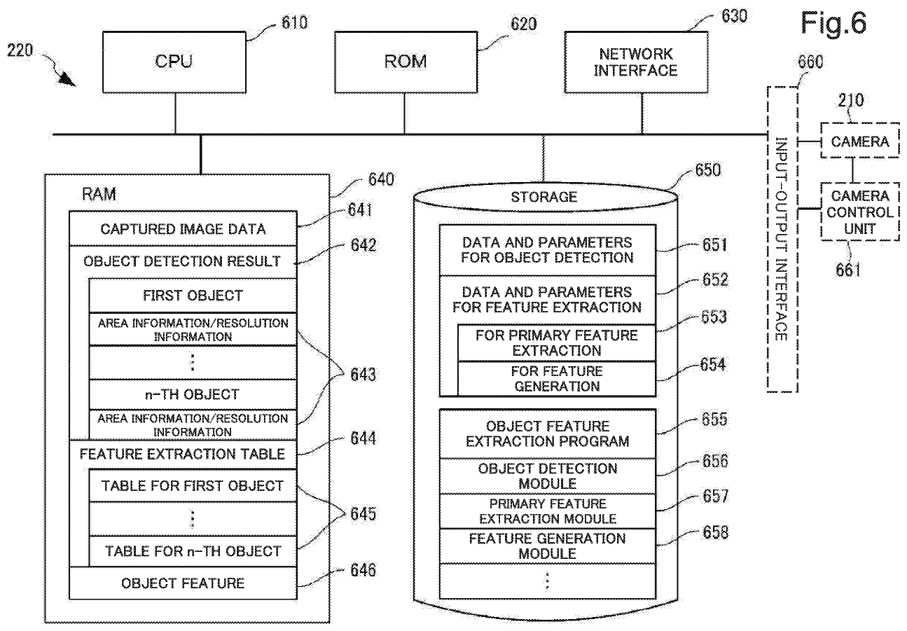

FIG. 6 is a block diagram illustrating a hardware configuration of the object feature extraction device (unit) 220 according to the present example embodiment.

In FIG. 6, a CPU 610 is a processor for operation control. A functional element unit of FIG. 4 is achieved by the CPU 610 executing a program. The CPU 610 includes a plurality of processors, and may concurrently execute different programs, modules, tasks, threads, and the like. A ROM 620 stores fixed data and program, such as initial data and a program. When the object feature extraction device (unit) 220 is separated from another equipment, a network interface 630 controls communication with a camera 210, the feature storage unit 230, an object tracking device including the object matching unit 240, or the like via a network.

A RAM 640 is a random access memory used by the CPU 610 as a temporary storage work area. In the RAM 640, an area for storing data necessary for achieving the present example embodiment is secured. Captured image data 641 are image data acquired from the camera 210. An object detection result 642 is a detection result of an object, which is detected based on the captured image data 641. The object detection result 642 stores sets of (object, and area information/resolution information 643) from (first object, and area information/resolution information) to (n-th object, and area information/resolution information). A feature extraction table 644 is a table for extracting an object feature on the basis of the captured image data 641, and the area information/resolution information 643. Tables 645 from a first object table to an n-th object table are stored in the feature extraction table 644. An object feature 646 is a feature of an object, which is extracted only from the object by using the feature extraction table 644.

A storage 650 stores a database, various parameters, and the following data and program necessary for achieving the present example embodiment. Data and parameters 651 for object detection are data and parameters used for detecting an object on the basis of the captured image data 641. Data and parameters 652 for feature extraction are data and parameters used for extracting an object feature on the basis of the captured image data 641 and the area information/resolution information 643. The data and parameters 652 for feature extraction include those for primary feature extraction 653, and those for feature generation 654.

The following programs are stored in the storage 650. An object feature extraction program 655 is a program for controlling the entirety of the object feature extraction device 220. An object detection module 656 is a module for detecting an object on the basis of the captured image data 641 by using the data and parameters 651 for object detection. A primary feature extraction module 657 is a module for extracting a primary feature on the basis of the captured image data 641 and area information by using data and parameters for primary feature extraction 653. A feature generation module 658 is a module for generating an object feature on the basis of a primary feature and resolution information by using data and parameters for feature generation 654.

When the object feature extraction device (unit) 220 is provided as an intelligent camera 250 in which the object feature extraction device (unit) 220 is integrally implemented together with the camera 210, the object feature extraction device (unit) 220 further includes an input-output interface 660, the camera 210 connected with the input-output interface 660, and a camera control unit 661 for controlling the camera 210.

In the RAM 640 and the storage 650 illustrated in FIG. 6, a program and data associated with a general-purpose function and another achievable function included in the object feature extraction device (unit) 220 are not illustrated.

(Feature Extraction Table)

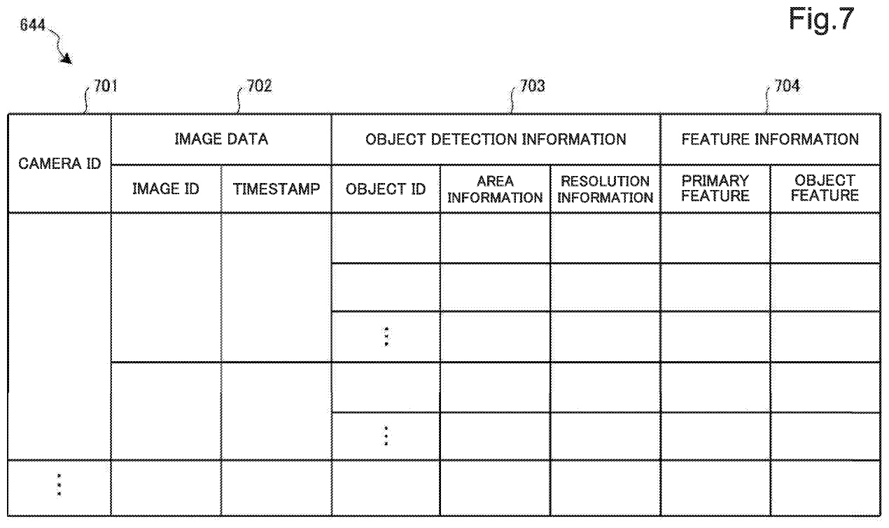

FIG. 7 is a diagram illustrating a configuration of the feature extraction table 644 in the object feature extraction device (unit) 220 according to the present example embodiment. The feature extraction table 644 is a table for use in extracting an object feature on the basis of captured image data and area information/resolution information.

In the feature extraction table 644, image data 702 captured by the camera are stored in association with a camera ID 701. The image data 702 includes an image ID, and a timestamp of time at which an image having the image ID is captured. The image also includes a still image and a moving image. Object detection information 703 and feature information 704 are stored in association with each piece of the image data 702. The object detection information 703 includes an object ID, area information, and resolution information. The feature information 704 includes a primary feature and an object feature.

<<Processing Procedure of Object Feature Extraction Device (Unit)>>

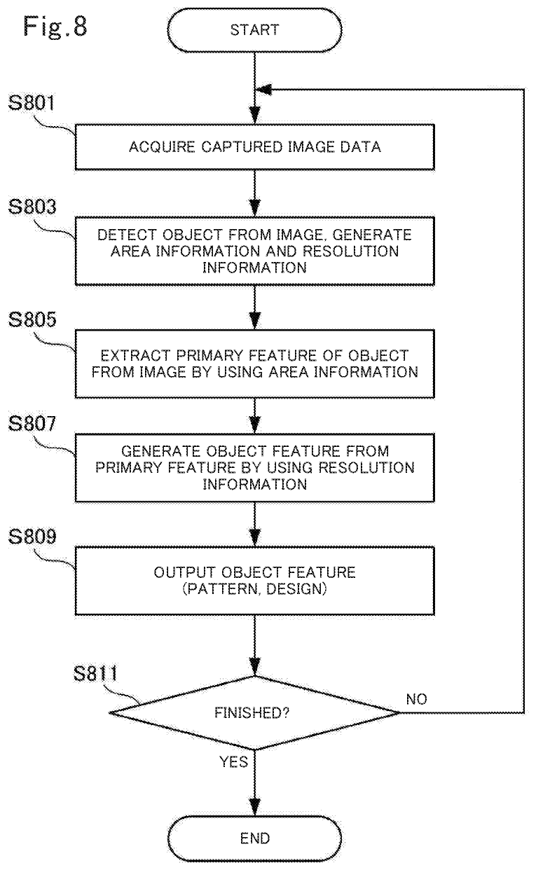

FIG. 8 is a flowchart illustrating a processing procedure of the object feature extraction device (unit) 220 according to the second example embodiment of the present invention. The CPU 610 in FIG. 6 executes the processing of this flowchart by using the RAM 640, and thereby the functional configuration unit of FIG. 4 is achieved. Hereinafter, the object feature extraction device (unit) 220 is briefly described as the feature extraction device 220.

In Step S801, the feature extraction device 220 acquires image data of an image captured by a camera. In Step S803, based on the image data, the feature extraction device 220 detects an object from the image, and generates area information and resolution information. In Step S805, based on the image data, the feature extraction device 220 extracts, from the image, a primary feature of the object by using the area information. In Step S807, the feature extraction device 220 generates an object feature from the primary feature by using the resolution information. In Step S809, the feature extraction device 220 outputs the object feature of a pattern and a texture of a garment, for example. In Step S811, the feature extraction device 220 determines if an instruction to finish the processing from an operator is received. When there is no instruction, the feature extraction device 220 repeats extraction and output of an object feature of an image from the camera.

(Matching Table)

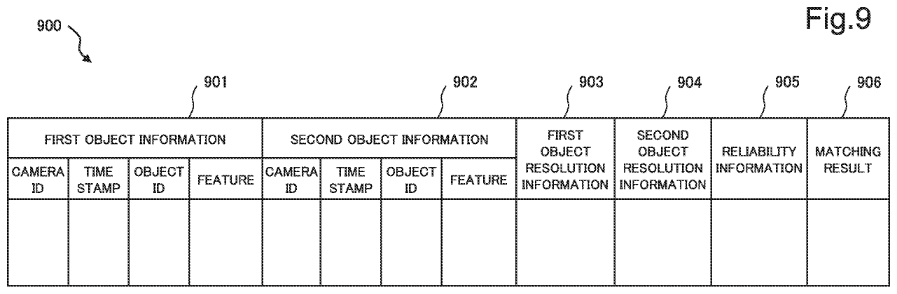

FIG. 9 is a diagram illustrating a configuration of a matching table 900 in the object matching unit 240 according to the present example embodiment. The matching table 900 is used for matching between features of at least two objects by the object matching unit 240 in consideration of resolution information.

In the matching table 900, first object information 901 and second object information 902 for matching are stored. The first object information 901 and the second object information 902 include a camera ID, a timestamp, an object ID, and a feature. First object resolution information 903, which is separated from a first object feature, and second object resolution information 904, which is separated from a second object feature, are stored in the matching table 900. Reliability information 905, which is determined from the first object resolution information 903 and the second object resolution information 904, and a matching result 906, which is acquired by matching between the first object feature and the second object feature with referring to the reliability information 905, are further stored in the matching table 900.

<<Processing Procedure of Object Matching Unit>>

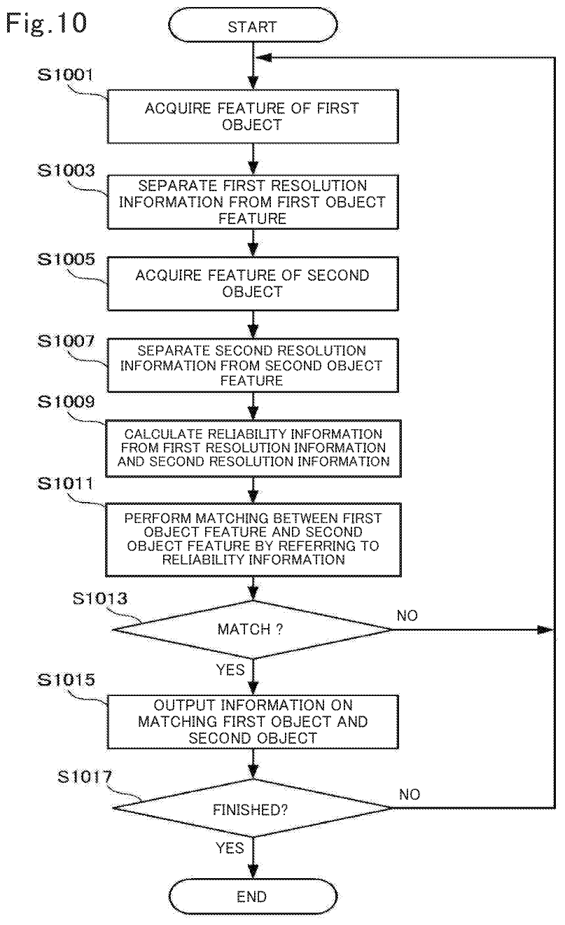

FIG. 10 is a flowchart illustrating a processing procedure of the object matching unit 240 according to the present example embodiment. An unillustrated CPU for controlling the object matching unit 240 executes the processing of this flowchart by using a RAM, and thereby the functional configuration unit of FIG. 4 is achieved.

In Step S1001, the object matching unit 240 acquires a feature of a first object. In Step S1003, the object matching unit 240 separates the first resolution information 903 from the first object feature. In Step S1005, the object matching unit 240 acquires a feature of a second object. In Step S1007, the object matching unit 240 separates the second resolution information 904 from the second object feature.

In Step S1009, the object matching unit 240 calculates the reliability information 905 from the first resolution information 903 and the second resolution information 904. In Step S1011, the object matching unit 240 performs matching between the first object feature and the second object feature with referring to the reliability information. In Step S1013, the object matching unit 240 determines if the first object feature and the second object feature match with each other. When the first object feature and the second object feature match with each other, in Step S1015, the object matching unit 240 outputs information on the first object and the second object matching with each other. In Step S1017, the object matching unit 240 determines if an instruction to finish the processing from an operator is received. When there is no instruction, the object matching unit 240 repeats object matching and output of a matching result.

According to the present example embodiment, an object feature is extracted in consideration of a change in feature depending on a resolution, and matching between the object features is performed in consideration of a degree of reliability based on resolution. Therefore, the present example embodiment is able to suppress tracking miss and search miss due to a matching error.

### Third Example Embodiment

Next, an object feature extraction device, and an object tracking system including the object feature extraction device according to a third example embodiment of the present invention are described. As compared with the above-described second example embodiment, the object feature extraction device, and the object tracking system including the object feature extraction device according to the present example embodiment of the present invention are different in a point that a feature extraction unit of the object feature extraction device, and an object matching unit for the object tracking system are achieved by one functional configuration unit. Since other configuration and operation are similar to those of the second example embodiment, the same signs are assigned to the same configurations and the same operations, and detailed description thereof is omitted.

<<Functional Configuration of Object Feature Extraction Device (Unit)>>

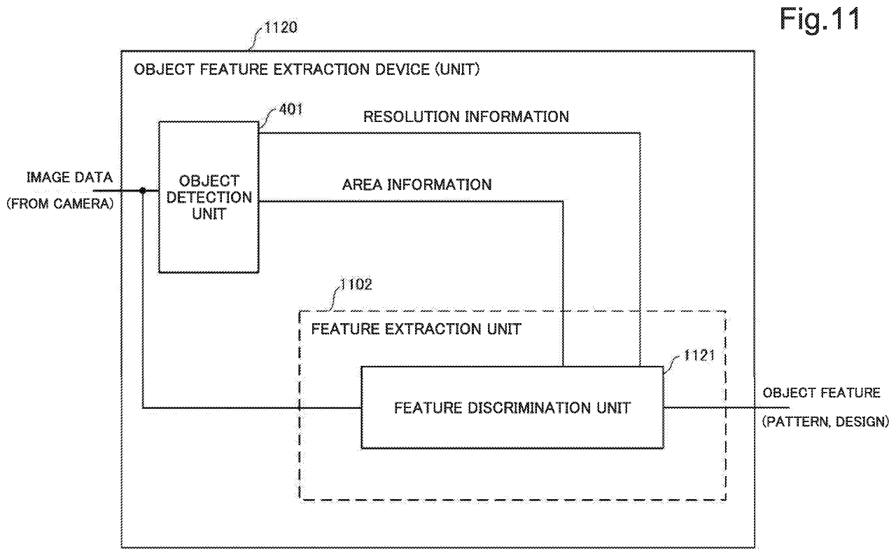

FIG. 11 is a block diagram illustrating a functional configuration of an object feature extraction device (unit) 1220 according to the present example embodiment. In FIG. 11, the same reference sign is assigned to a functional configuration unit similar to that in FIG. 4, and duplicate description thereof is omitted.

(Configuration)

The object feature extraction device (unit) 1120 includes an object detection unit 401 and a feature extraction unit 1102 including one feature discriminating unit 1121. The feature discriminating unit 1121 receives area information and resolution information generated by the object detection unit 401 and image data as an input, generates a feature, and outputs the feature as an object feature.

(Operation)

The area information and the resolution information, and the image data are input to the feature discriminating unit 1121. The feature discriminating unit 1121 is, for example, a classifier which has learned in such a way as to classify features of various patterns captured at various resolutions. When a pattern is used as a feature, the input is pixel values and resolution information of a subarea within a garment area, and the output is a likelihood of a feature of each of patterns (which takes a value from “0” to “1”, and as the value of the likelihood of a pattern of a feature approaches “1”, a possibility that the input represents the feature of the pattern is higher). When classification of features of N patterns is performed, likelihoods of the features of the N patterns are the output, and this output is set as a feature indicating a pattern and a texture.

When a feature is acquired from a plurality of subareas, likelihoods to which likelihoods derived for the subareas are united may be set as a feature indicating a pattern and a texture. The classifier may be implemented using a neural network, for example. At this occasion, a classifier which is used may have been trained by inputting pixel values and a resolution altogether. Alternatively, classifiers which may be used may have been trained individually for a plurality of resolutions, and a classifier may be selected on the basis of resolution information and be used. A plurality of subareas may be input. In this case, any of the plurality of subareas may overlap or may not overlap one another. All sizes of the subareas may be the same, or the subareas may include subareas whose sizes are different. Sizes of the subareas may be normalized on the basis of a size of a garment area.

Description is made by using a pattern of a garment as an example. When the object is another tracking target such as a car, for example, a feature capable of suppressing tracking miss and search miss due to a matching error is selected, and a feature of the feature is extracted.

<<Functional Configuration of Object Matching Unit>>

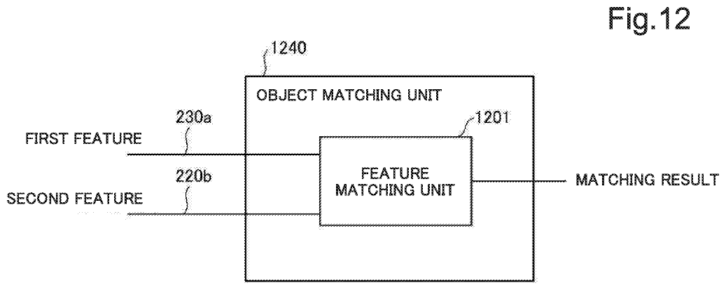

FIG. 12 is a block diagram illustrating a functional configuration of an object matching unit 1240 according to the present example embodiment. In FIG. 12, the same reference signs are assigned to elements similar to those in FIG. 5, and duplicate description thereof is omitted.

The object matching unit 1240 in FIG. 12 includes one feature matching unit 1201. A first feature 230a and a second feature 220b are input to the feature matching unit 1201. The feature matching unit 1201 calculates a degree of similarity between the first and second features 230a and 220b in which resolution information is incorporated, determines if a first object and a second object are identical to each other, and outputs determination result as a matching result.

The present example embodiment is able to extract an object feature in consideration of a change in feature depending on a resolution with a more simplified configuration, perform matching between the object features in consideration of a degree of reliability by the resolution, and suppress tracking miss and search miss due to a matching error.

### Fourth Example Embodiment

Next, an object matching unit of an object tracking system according to a fourth example embodiment of the present invention is described. As compared with the second example embodiment, the object matching unit according to the present example embodiment is different in a point that a reliability calculation unit is not provided, and separated first and second resolution information are directly input to a feature matching unit. Since other configuration and operation are similar to those of the second example embodiment, the same signs are assigned to the same configurations and operations, and detailed description thereof is omitted.

<<Functional Configuration of Object Matching Unit>>

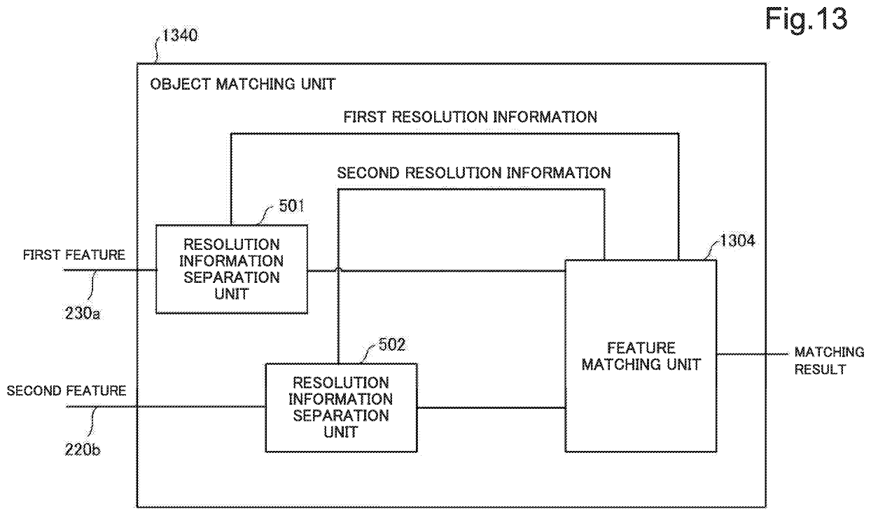

FIG. 13 is a block diagram illustrating a functional configuration of an object matching unit 1340 according to the present example embodiment. In FIG. 13, the same reference signs are assigned to functional configuration units similar to those in FIG. 5, and description thereof is omitted.

(Configuration)

Referring to FIG. 13, the object matching unit 1340 includes a resolution information separation unit 501, a resolution information separation unit 502, and a feature matching unit 1304. The feature matching unit 1304 performs matching between data on a first feature output from the resolution information separation unit 501, and data on a second feature output from the resolution information separation unit 502 by using first resolution information, which is output from the resolution information separation unit 501, and second resolution information, which is output from the resolution information separation unit 502, and outputs the matching result.

(Operation)

The feature matching unit 1304 compares between the data on the first feature and the data on the second feature, and determines if objects are identical to each other. At this occasion, the first resolution information and the second resolution information are also input to the feature matching unit 1304, and used for matching. For example, the feature matching unit 1304 determines a degree indicating that the data on the first feature and the data on the second feature are identical to each other by using a discriminator which has learned a probability of matching for each resolution, and outputs determination result as a matching result. Also in this case, the matching result that is output may not be a binary value as to whether objects are identical to each other, but a numerical value indicating a degree of matching.

The present example embodiment is capable of suppressing tracking miss and search miss due to a matching error without a reliability calculation unit, i.e. with an object matching unit having a more simplified configuration.

### Fifth Example Embodiment

Next, an object feature extraction device according to a fifth example embodiment of the present invention is described. As compared with the above-described second and third example embodiments, the object feature extraction device according to the present example embodiment is different in a point that a change in feature is learned by object tracking, and a learning result is reflected on extraction of an object feature. Since other configuration and operation are similar to those of the second or third example embodiment, the same signs are assigned to the same configurations and operations, and detailed description thereof is omitted.

<<Functional Configuration of Object Feature Extraction Device (Unit)>>

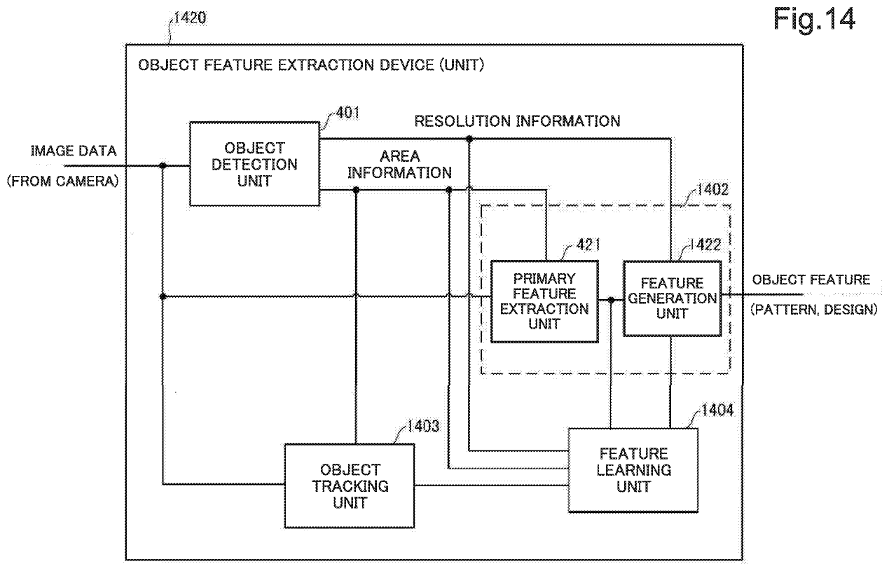

FIG. 14 is a block diagram illustrating a functional configuration of an object feature extraction device (unit) 1420 according to the present example embodiment. In FIG. 14, the same reference signs are assigned to functional configuration units similar to those in FIG. 4, and duplicate description thereof is omitted.

(Configuration)

Referring to FIG. 14, the object feature extraction device (unit) 1420 includes an object detection unit 401, a feature extraction unit 1402, an object tracking unit 1403, and a feature learning unit 1404. The object detection unit 401 is similar to that in FIG. 4.

The object tracking unit 1403 performs tracking of an object between frames on the basis of area information output from the object detection unit 401 and input image data of an image , and outputs a tracking identifier (hereinafter, referred to as a tracking ID) of the object. The feature learning unit 1404 learns a change in feature caused by a change of resolution by using resolution information and area information output from the object detection unit 401, a tracking result output from the object tracking unit 1403, and a primary feature output from a primary feature extraction unit 421 of the feature extraction unit 1402, and outputs a learning result to a feature generation unit 1422 of the feature extraction unit 1402. The feature generation unit 1422 extracts, from the image data, the area information and the resolution information output from the object detection unit 401, and the learning result on the feature output from the feature learning unit 1404, a feature such as a pattern and a texture of the object, and outputs the feature as an object feature.

(Operation)

An operation of the object detection unit 401 is similar to the operation illustrated in FIG. 4. The object detection unit 401 outputs resolution information and area information for each of detected objects. The output resolution information is input to the primary feature extraction unit 421 of the feature extraction unit 1402. Meanwhile, the output resolution information is also input to the object tracking unit 1403 and the feature learning unit 1404, as well as to the feature generation unit 1422 of the feature extraction unit 1402.

The object tracking unit 1403 associates an input result of object detection with an object tracking result which has been acquired so far, and thereby calculates a tracking result with respect to a current frame. At this occasion, existing various methods may be employed for tracking. For example, it is possible to employ tracking by a Kalman filter, and is also possible to employ a tracking method by a particle filter. Consequently, a tracking ID is calculated for each of the detected objects. The calculated tracking ID is output to the feature learning unit 1404.

The feature learning unit 1404 learns an influence on a feature by resolution on the basis of resolution information and area information output from the object detection unit 401 for each of the objects, tracking ID information output from the object tracking unit 1403 for each of the objects, and a primary feature output from the primary feature extraction unit 421 of the feature extraction unit 1402 for each of the objects, and acquires posterior probability information with respect to each resolution.

First, primary features associated with a same tracking ID are grouped. At this occasion, grouping may be performed further in consideration of a position in an object area. For example, when a feature belongs to an m-th subarea of a person having a same tracking ID, features located at the same m-th subarea are collected and grouped. Here, association is maintained in such a way that the associated resolution information is easily acquired from individual features that have been grouped. Next, a visual keyword, among visual keywords xₙ (n=1, . . . , N), to which an original feature pattern belongs is acquired based on, among the group of features, a feature having a resolution equal to or higher than a predetermined resolution. Thus, by using the feature of this group, how xₙ varies by resolution is confirmed. By repeating this learning with respect to a plurality of persons of which tracking has been securely performed, how each xₙ varies by resolution is learned. The learning result is output to the feature generation unit 1422 of the feature extraction unit 1402, and is used in succeeding feature generation.

Thus, since an influence on a feature by variation depending on resolution is automatically learned for each of cameras, it becomes possible to acquire a feature more appropriate for identification of a feature pattern. When the object is a person, online learning may be performed by using data, based on a premise that the number of persons is less and a tracking error does not occur, in an actual operation. Alternatively, when a pattern of a garment is used as a feature, learning may be performed at the time of installation by letting a person walk while wearing garments of various patterns, and then the system may be used. At this occasion, learning may be performed in such a way that a person wears garments on which various features are depicted.

(Feature Extraction Table)

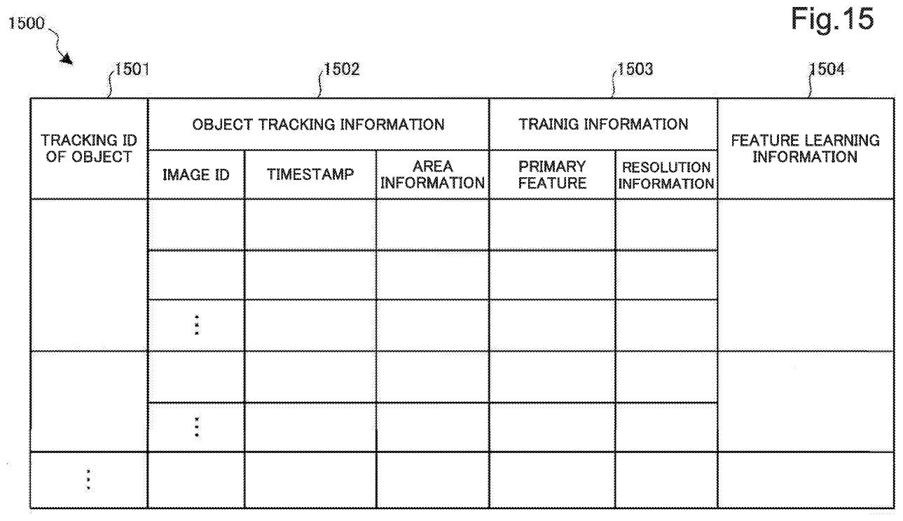

FIG. 15 is a diagram illustrating a configuration of a feature extraction table 1500 in the object feature extraction device (unit) 1420 according to the present example embodiment. The feature extraction table 1500 is a table for use in extracting, based on captured image data and area information/resolution information, an object feature by using a learning result by object tracking.

The feature extraction table 1500 stores object tracking information 1502 and training information 1503 in association with each of object tracking IDs 1501. Feature learning information 1504 is generated from the object tracking information 1502 and the training information 1503.

The object tracking information 1502 includes an image ID, a timestamp, and area information. The training information 1503 includes a primary feature and resolution information.

<<Processing Procedure of Object Feature Extraction Device (Unit)>>

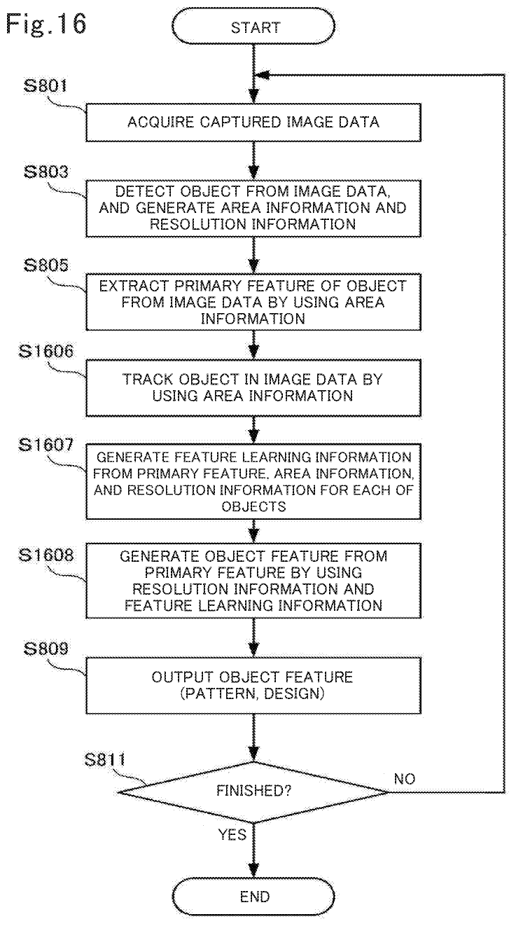

FIG. 16 is a flowchart illustrating a processing procedure of the object feature extraction device (unit) 1420 according to the present example embodiment. A CPU 610 executes the processing of the flowchart by using a RAM 640, so that the functional configuration unit of FIG. 14 is achieved. In FIG. 16, to the steps similar to those in FIG. 8, the same step numbers are assigned, and duplicate description thereof is omitted. The object feature extraction device (unit) 1420 is briefly described as the feature extraction device 1420.

In Step S1606, the feature extraction device 1420 tracks an object in image data by using area information. In Step S1607, the feature extraction device 1420 generates feature learning information from a primary feature, area information, and resolution information, for each object. In Step S1608, the feature extraction device 1420 generates an object feature from the primary feature by using the resolution information and the feature learning information.

According to the present example embodiment, learning a change in feature by object tracking is performed and an object feature reflecting a learning result is extracted, the present example embodiment is capable of generating an object feature, while further suppressing tracking miss and search miss by a matching error.

### Sixth Example Embodiment

Next, an object feature extraction unit of an object tracking system according to a sixth example embodiment of the present invention is described. As compared with the above-described second to fifth example embodiments, the object feature extraction unit according to the present example embodiment is different in a point that an object tracking device as a server which performs object tracking processing extracts an object feature. Since other configuration and operation are similar to those in the second to fifth example embodiments, the same reference signs are assigned to the same configuration and operation, and detailed description thereof is omitted.

<<Functional Configuration of Object Feature Extraction Device (Unit)>>

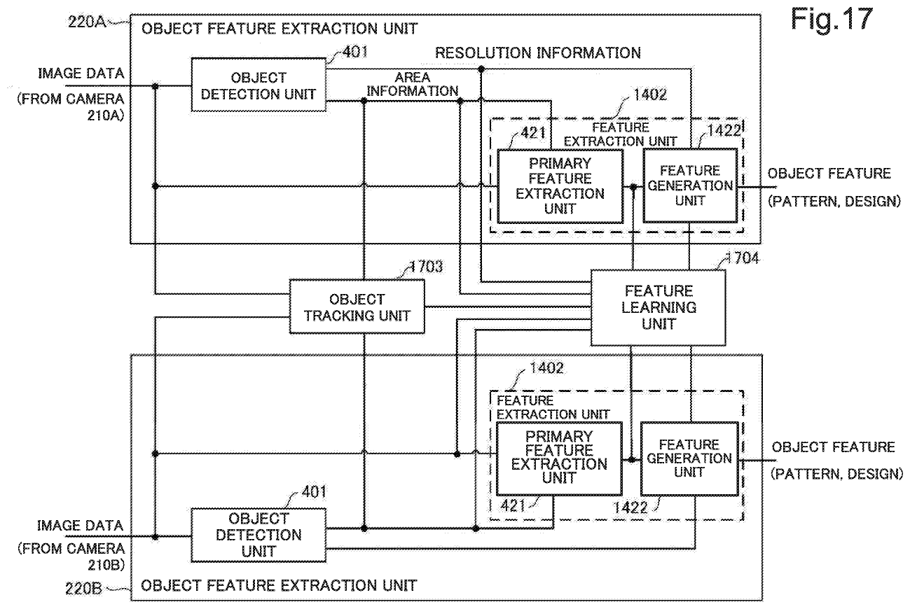

FIG. 17 is a block diagram illustrating a functional configuration of an object feature extraction device (unit) according to the present example embodiment. In FIG. 17, the same reference signs are assigned to the functional configuration units similar to those in FIG. 4 or FIG. 14, and duplicate description thereof is omitted.

An object tracking unit 1703 performs tracking an object on the basis of image data from at least two cameras, as illustrated in FIG. 17, instead of tracking an object on the basis of an image from one camera as illustrated in FIG. 14. A feature learning unit 1704 learns a feature of an object by using tracking information from the object tracking unit 1703, and primary features from at least two primary feature extraction units 421, and outputs a learning result for feature generation by at least two feature generation units 1422.

According to the present example embodiment, a server which performs object tracking processing performs object feature extraction and object tracking at the same time, which is different from the separated object feature extraction device and an intelligent imaging device of the second example embodiment in which a camera and an object feature extraction unit are integrated. Therefore, it is possible to speedily perform efficient object tracking by using information in a wider range.

### Other Example Embodiments

In the foregoing, the invention of the present application is described with reference to the example embodiments. The invention of the present application, however, is not limited to the above-described example embodiments. A configuration and details of the invention of the present application may be modified in various ways comprehensible to a person skilled in the art within the scope of the invention of the present application. A system or a device including any combination of individual features included in each of the example embodiments is also included within the scope of the present invention. For example, the configuration of a set of an “object feature extraction device (unit)” and an “object matching unit” is not limited to that in the above-described example embodiments, and configurations of different example embodiments may be synthesized.

The present invention is able to track a specific object (such as a person or a car) by using, for example, cameras at two locations away from each other. For example, when an incident occurs, the present invention may be used for the purpose of tracking a suspect by using a plurality of cameras. When there is a stray child, it is possible to use the present invention for the purpose of finding the stray child by searching among a plurality of cameras.

The present invention may be applied to a system including a plurality of devices, or may be applied to a single device. Further, the present invention is also applicable to a case where an information processing program that achieves functions of the example embodiments is directly or remotely supplied to a system or a device. Therefore, a program to be installed in a computer in order to achieve the functions of the present invention by the computer, a medium storing the program, and a world wide web (WWW) server which causes a computer to download the program are included within the scope of the present invention. In particular, a non-transitory computer readable medium storing a program causing a computer to execute at least processing steps included in the above-described example embodiments is included within the scope of the present invention.

### Other Expression of Example Embodiments

A part or the entirety of the above-described example embodiments may be described as the following supplementary notes, but are not limited to the following.

(Supplementary Note 1)

An object feature extraction device including:

object detection means for detecting an object from an image, and generating area information indicating an area where the object is present, and resolution information pertaining to resolution of the object; and

feature extraction means for extracting, from the image within an area defined by the area information, a feature indicating a feature of the object in consideration of the resolution information.

(Supplementary Note 2)

The object feature extraction device according to Supplementary Note 1, wherein

the feature extraction means extracts, from the image within an area defined by the area information, a primary feature, and generates the feature indicating the feature of the object by separably adding the resolution information to the primary feature.

(Supplementary Note 3)

The object feature extraction device according to Supplementary Note 1, wherein

the feature extraction means generates the feature indicating the feature of the object by converting, based on the resolution information, a feature extracted from the image within the area defined by the area information.

(Supplementary Note 4)

The object feature extraction device according to Supplementary Note 3, wherein

the feature extraction means acquires a likelihood, based on the resolution information, with respect to the feature extracted from the image within the area defined by the area information, and generates the feature indicating the feature of the object, based on the acquired likelihood.

(Supplementary Note 5)

The object feature extraction device according to any one of Supplementary Notes 1 to 4, wherein

the feature extraction means makes the feature consist of likelihoods output by a discriminator for a plurality of subareas included in the image within the area defined by the area information, the discriminator being learned for each resolution indicated by the resolution information.

(Supplementary Note 6)

The object feature extraction device according to Supplementary Note 2, further including:

object tracking means for determining, by comparing features from time series of images within areas defined by the area information, an identical object between images of different points of time, and generating and outputting a tracking identifier identifying the identical object; and

feature learning means for grouping the primary feature calculated by the feature extraction means based on the area information, the resolution information, and the tracking identifier, estimating an original feature based on the primary feature acquired from an area having a higher resolution in a group, learning how a value of the estimated original feature varies with resolution, and feeding back a learning result to the feature extraction means.

(Supplementary Note 7)

An object tracking system including a first object feature extraction device and a second object feature extraction device each of which is the object feature extraction device according to any one of Supplementary Notes 1 to 6, including:

feature storage means for storing a first feature in an area of an object detected from a first image by the first object feature extraction device, the first feature including first resolution information; and

object matching means for performing matching between a second feature including second resolution information and a first feature including the first resolution information, the first feature read from the feature storage means, the second feature being a feature in an area of an object detected from a second image by the second object feature extraction device, the second image being different from the first image, and determining if objects are identical to each other in consideration of the first resolution information and the second resolution information.

(Supplementary Note 8)

An intelligent imaging device including:

at least an imaging unit; and an object feature extraction unit, wherein

the object feature extraction unit includes:
object detection means for detecting an object from an image captured by the imaging unit, and generating area information and resolution information, the area information indicating an area where the object is present, the resolution information pertaining to resolution of the object; and
feature extraction means for extracting, from the image within an area defined by the area information, a feature indicating a feature of the object in consideration of the resolution information.

(Supplementary Note 9)

An object feature extraction method including:

detecting an object from an image, and generating area information indicating an area where the object is present, and resolution information pertaining to resolution of the object; and

extracting, from the image within an area defined by the area information, a feature indicating a feature of the object in consideration of the resolution information.

(Supplementary Note 10)

The object feature extraction method according to Supplementary Note 9, wherein

the extracting includes extracting, from the image within an area defined by the area information, a primary feature, and generating the feature indicating the feature of the object by separably adding the resolution information to the primary feature.

(Supplementary Note 11)

The object feature extraction method according to Supplementary Note 9, wherein

the extracting includes generating the feature indicating the feature of the object by converting, based on the resolution information, a feature extracted from the image within the area defined by the area information.

(Supplementary Note 12)

The object feature extraction method according to Supplementary Note 11, wherein

the extracting includes acquiring a likelihood, based on the resolution information, with respect to the feature extracted from the image within the area defined by the area information, and generating the feature indicating the feature of the object, based on the acquired likelihood.

(Supplementary Note 13)

The object feature extraction method according to any one of Supplementary Notes 9 to 12, wherein

the extracting includes setting the feature to likelihoods output by a discriminator for a plurality of subareas included in the image within the area defined by the area information, the discriminator being learned for each resolution indicated by the resolution information.

(Supplementary Note 14)

The object feature extraction method according to Supplementary Note 10, further including:

determining, by comparing features from time series of images within areas defined by the area information, an identical object between images of different points of time, and generating and outputting a tracking identifier identifying the identical object; and

grouping the primary feature calculated by the extracting the feature based on the area information, the resolution information, and the tracking identifier, estimating an original feature based on the primary feature acquired from an area having a higher resolution in a group, learning how a value of the estimated original feature varies with resolution, and feeding back a learning result to the extracting the feature.

(Supplementary Note 15)

An object tracking method performing matching between a first feature and a second feature each of which is extracted by the object feature extraction method according to any one of Supplementary Notes 9 to 14, the object tracking method including:

performing matching between a second feature and a first feature including first resolution information, the first feature read from feature storage means, and determining if objects are identical to each other in consideration of the first resolution information and the second resolution information, wherein

the first feature is a feature in an area of an object detected from a first image, includes the first resolution information, and is stored in the feature storage means, and

the second feature is a feature in an area of an object detected from a second image different from the first image, and includes second resolution information.

(Supplementary Note 16)

An intelligent imaging method including:

detecting an object from an image captured by an imaging unit, and generating area information and resolution information, the area information indicating an area where the object is present, the resolution information pertaining to resolution of the object; and

extracting, from the image within an area defined by the area information, a feature indicating a feature of the object in consideration of the resolution information.

(Supplementary Note 17)

A storage medium storing an object feature extraction program causing a computer to execute:

object detection processing of detecting an object from an image, and generating area information indicating an area where the object is present, and resolution information pertaining to resolution of the object; and

feature extraction processing of extracting, from the image within an area defined by the area information, a feature indicating a feature of the object in consideration of the resolution information.

(Supplementary Note 18)

The storage medium according to Supplementary Note 17, wherein

the feature extraction processing extracts, from the image within an area defined by the area information, a primary feature, and generates the feature indicating the feature of the object by separably adding the resolution information to the primary feature.

(Supplementary Note 19)

The storage medium according to Supplementary Note 17, wherein

the feature extraction processing generates the feature indicating the feature of the object by converting, based on the resolution information, a feature extracted from the image within the area defined by the area information.

(Supplementary Note 20)

The storage medium according to Supplementary Note 19, wherein

the feature extraction processing acquires a likelihood, based on the resolution information, with respect to the feature extracted from the image within the area defined by the area information, and generates the feature indicating the feature of the object, based on the acquired likelihood.

(Supplementary Note 21)

The storage medium according to any one of Supplementary Notes 17 to 20, wherein

the feature extraction processing makes the feature consist of likelihoods output by a discriminator for a plurality of subareas included in the image within the area defined by the area information, the discriminator being learned for each resolution indicated by the resolution information.

(Supplementary Note 22)

The storage medium according to Supplementary Note 18, the program further causing a computer to execute:

object tracking processing of determining, by comparing features from time series of images within areas defined by the area information, an identical object between images of different points of time, and generating and outputting a tracking identifier identifying the identical object; and

feature learning processing of grouping the primary feature calculated by the feature extraction processing based on the area information, the resolution information, and the tracking identifier, estimating an original feature based on the primary feature acquired from an area having a higher resolution in a group, learning how a value of the estimated original feature varies with resolution, and feeding back a learning result to the feature extraction processing.

(Supplementary Note 23)

A storage medium storing an object tracking program causing a third computer, the third computer being connected with a feature storage means and a second computer, the feature storage means being connected with a first computer, each of the first computer and the second computer executing the object feature extraction program stored in the storage medium according to any one of Supplementary Notes 17 to 22, to execute

object matching processing of performing matching between a second feature including second resolution information and a first feature including the first resolution information, the first feature read from the feature storage means, and determining if objects are identical to each other in consideration of the first resolution information and the second resolution information, wherein

the first feature is a feature in an area of an object detected from a first image by the first computer and includes the first resolution information, and

the second feature is a feature in an area of an object detected from a second image that is different from the first image by the second computer and includes the second resolution information.

(Supplementary Note 24)

A storage medium storing an intelligent imaging program causing a computer connected with a imaging unit to execute:

object detection processing of detecting an object from an image captured by the imaging unit, and generating area information and resolution information, the area information indicating an area where the object is present, the resolution information pertaining to resolution of the object; and

feature extraction processing of extracting, from the image within an area defined by the area information, a feature indicating a feature of the object in consideration of the resolution information.

In the foregoing, the present invention is described with reference to the example embodiments. The invention of the present application, however, is not limited to the above-described example embodiments. A configuration and details of the present invention may be modified within the scope of the invention of the present application in various ways comprehensible to a person skilled in the art.

This application claims the priority based on Japanese Patent Application No. 2017-055913 filed on Mar. 22, 2017, the disclosure of which is incorporated herein in its entirety.

### REFERENCE SIGNS LIST

100 Object feature extraction device
101 Object detection unit
102 Feature extraction unit
110 Image
111 Area information
112 Resolution information
121 Object feature
200 Object tracking system
210 Camera
210A Camera
210B Camera
220 Feature extraction device
220 Object feature extraction device (unit)
220A Object feature extraction unit
220b Second feature
220B Object feature extraction device (unit)
230 Feature storage unit
230a First feature
240 Object matching unit
250 Intelligent camera
250A Intelligent camera
401 Object detection unit
402 Feature extraction unit
421 Primary feature extraction unit
422 Feature generation unit
501 Resolution information separation unit
502 Resolution information separation unit
503 Reliability calculation unit
504 Feature matching unit
630 Network interface
641 Captured image data
642 Object detection result
643 Resolution information
644 Feature extraction table
645 Table
646 Object feature
650 Storage
651 Parameter
652 Parameter
653 For primary feature extraction
654 For feature generation
655 Object feature extraction program
656 Object detection module
657 Primary feature extraction module
658 Feature generation module
660 Input-output interface
661 Camera control unit
702 Image data
703 Object detection information
704 Feature information
900 Matching table
901 First object information
902 Second object information
903 Resolution information
903 First resolution information
904 Resolution information
904 Second resolution information
905 Reliability information
906 Matching result
1102 Feature extraction unit
1120 Object feature extraction device (unit)
1121 Feature discrimination unit
1201 Feature matching unit
1220 Object feature extraction device (unit)
1240 Object matching unit
1304 Feature matching unit
1340 Object matching unit
1402 Feature extraction unit
1403 Object tracking unit
1404 Feature learning unit
1420 Feature extraction device
1420 Object feature extraction device (unit)
1422 Feature generation unit
1500 Feature extraction table
1502 Object tracking information
1503 Training information
1504 Feature learning information
1703 Object tracking unit
1704 Feature learning unit

What is claimed is:

1. An object feature extraction device comprising:
at least one memory storing instructions; and
at least one processor configured to execute the instructions to: detect an object from an image, and generate area information indicating an area where the object is present, and resolution information pertaining to resolution of the object; and
extract, from the image within an area defined by the area information, a feature indicating a feature of the object in consideration of the resolution information.

2. The object feature extraction device according to claim 1, wherein
the at least one processor is further configured to
extract from the image within an area defined by the area information, a primary feature, and generate the feature indicating the feature of the object by separably adding the resolution information to the primary feature.

3. The object feature extraction device according to claim 1, wherein the at least one processor is further configured to
generate the feature indicating the feature of the object by converting, based on the resolution information, a feature extracted from the image within the area defined by the area information.

4. The object feature extraction device according to claim 3, wherein
the at least one processor is further configured to
acquire a likelihood, based on the resolution information, with respect to the feature extracted from the image within the area defined by the area information, and generate the feature indicating the feature of the object, based on the acquired likelihood.

5. The object feature extraction device according to claim 1, wherein
the at least one processor is further configured to
make the feature consist of likelihoods output by a discriminator for a plurality of subareas included in the image within the area defined by the area information, the discriminator being learned for each resolution indicated by the resolution information.

6. The object feature extraction device according to claim 2, wherein
the at least one processor is further configured to:
determine by comparing features from time series of images within areas defined by the area information, an identical object between images of different points of time, and generate and output a tracking identifier identifying the identical object; and
group the primary feature calculated by the feature extraction means based on the area information, the resolution information, and the tracking identifier, estimate an original feature based on the primary feature acquired from an area having a higher resolution in a group, learning how a value of the estimated original feature varies with resolution, and feed back a learning result to the feature extraction means.

7. An object tracking system including a first object feature extraction device and a second object feature extraction device each of which is the object feature extraction device according to claim 1, comprising:
at least one second memory storing instructions and a first feature in an area of an object detected from a first image by the first object feature extraction device, the first feature including first resolution information; and
at least one second processor configured to execute the instructions to:
perform matching between a second feature including second resolution information and a first feature including the first resolution information, the first feature read from the at least one second memory, the second feature being a feature in an area of an object detected from a second image by the second object feature extraction device, the second image being different from the first image, and determine if objects are identical to each other in consideration of the first resolution information and the second resolution information.

8. An intelligent imaging device comprising:
at least an imaging device;
at least one memory storing instructions; and
at least one processor configured to execute the instructions to:
detect an object from an image captured by the imaging unit, and generate area information and resolution information, the area information indicating an area where the object is present, the resolution information pertaining to resolution of the object; and
extract, from the image within an area defined by the area information, a feature indicating a feature of the object in consideration of the resolution information.

9. An object feature extraction method comprising:
detecting an object from an image, and generating area information indicating an area where the object is present, and resolution information pertaining to resolution of the object; and
extracting, from the image within an area defined by the area information, a feature indicating a feature of the object in consideration of the resolution information.

10. The object feature extraction method according to claim 9, wherein
the extracting includes extracting, from the image within an area defined by the area information, a primary feature, and generating the feature indicating the feature of the object by separably adding the resolution information to the primary feature.

11. The object feature extraction method according to claim 9, wherein
the extracting includes generating the feature indicating the feature of the object by converting, based on the resolution information, a feature extracted from the image within the area defined by the area information.

12. The object feature extraction method according to claim 11, wherein
the extracting includes acquiring a likelihood, based on the resolution information, with respect to the feature extracted from the image within the area defined by the area information, and generating the feature indicating the feature of the object, based on the acquired likelihood.

13. The object feature extraction method according to claim 9, wherein
the extracting includes making the feature consist of likelihoods output by a discriminator for a plurality of subareas included in the image within the area defined by the area information, the discriminator being learned for each resolution indicated by the resolution information.

14. The object feature extraction method according to claim 10, further comprising:
determining, by comparing features from time series of images within areas defined by the area information, an identical object between images of different points of time, and generating and outputting a tracking identifier identifying the identical object; and
grouping the primary feature calculated by the extracting the feature based on the area information, the resolution information, and the tracking identifier, estimating an original feature based on the primary feature acquired from an area having a higher resolution in a group, learning how a value of the estimated original feature varies with resolution, and feeding back a learning result to the extracting the feature.

15. An object tracking method performing matching between a first feature and a second feature each of which is extracted by the object feature extraction method according to claim 9, the object tracking method comprising:
performing matching between a second feature and a first feature including first resolution information, the first feature read from feature storage, and determining if objects are identical to each other in consideration of the first resolution information and the second resolution information, wherein
the first feature is a feature in an area of an object detected from a first image, includes the first resolution information, and is stored in the feature, and
the second feature is a quantity in an area of an object detected from a second image different from the first image, and includes second resolution information.

16-24. (canceled)
